(19) United States
(12) Patent Application Publication
(10) Pub. No.: US 2022/0274539 A1
(43) Pub. Date: Sep. 1, 2022

(54) SOUND TRANSMISSION ANALYZER FOR PANEL MEMBER OF VEHICLE

(71) Applicant: Toyota Jidosha Kabushiki Kaisha, Toyota-shi Aichi-ken (JP)

(72) Inventors: Kai Aizawa, Toyota-shi Aichi-ken (JP); Hidenori Morita, Okazaki-shi Aichi-ken (JP); Norimasa Kobayashi, Nagoya-shi Aichi-ken (JP); Seigo Yamamoto, Toyota-shi Aichi-ken (JP)

(21) Appl. No.: 17/678,660

(22) Filed: Feb. 23, 2022

(30) Foreign Application Priority Data
Feb. 26, 2021 (JP) 2021-030251

(51) Int. Cl. B60R 13/08; G01H 15/00; G01H 5/00

(52) U.S. Cl. CPC B60R 13/0815; G01H 15/00; G01H 5/00

(57) ABSTRACT

This storage unit is configured to store an outside-of-panel acoustic transfer function that is an acoustic transfer function involving an airborne sound that is a sound emitted from a sound source located outside a panel member and propagated through the air to an outer surface of the panel member, and a panel transmission function that is an acoustic transfer function from the outer surface of the panel member to an inner surface of the panel member. This sound transmission analyzing unit is configured to calculate, based on the outside-of-panel acoustic transfer function and the panel transmission function, an acoustic transfer function from the sound source via the air to the inner surface of the panel member.

### CROSS REFERENCE TO RELATED APPLICATION

This application claims priority to Japanese Patent Application No. 2021-030251 filed on Feb. 26, 2021, which is incorporated herein by reference in its entirety including the specification, claims, drawings, and abstract.

### TECHNICAL FIELD

The present specification discloses a sound transmission analyzer for a panel member of a vehicle.

### BACKGROUND

Conventionally, technologies have been proposed which can be used to analyze sound radiated to the inner side of a panel member (e.g., a cabin) of a vehicle when the panel member vibrates.

For example, JP 2019-114114A discloses a vehicle panel member vibration analyzer configured to calculate a sound pressure sensitivity P/F indicating the relationship between external force F and a sound pressure P at a measurement position on the basis of equivalent radiated power (acoustic energy radiated from a vehicle panel) of the panel member when the external force F is imposed on the panel member of the vehicle, a soundproof material surface vibration ratio that is a ratio between vibration amplitudes of the panel member and a soundproof material provided on the inner side of the panel member, and an acoustic transfer function from an inner surface of the panel member to a preset measurement position, which are obtained by simulation.

In the technology according to JP 2019-114114A, the sound pressure sensitivity P/F involving the external force F imposed on the panel member is calculated. Here, the external force F in JP 2019-114114A corresponds to an input of force that generates vibrations transmitted through an object (solid propagating sound). That is, in the technology according to JP 2019-114114A, the sound pressure sensitivity P/F for the solid propagating sound is calculated.

However, an airborne sound propagating through the air from a sound source may be input to the panel member. Thus, it is useful to obtain an acoustic transfer function involving the transmission sound in which the sound pressure is transmitted through the panel member in consideration of the airborne sound input to the panel member.

The purpose of a sound transmission analyzer for a panel member of a vehicle as disclosed herein is to obtain an acoustic transfer function involving a transmission sound transmitted through the panel member from a sound source in consideration of an airborne sound that propagates through the air from the sound source outside the panel member and is input to an outer surface of the panel member.

### SUMMARY

A sound transmission analyzer for a panel member of a vehicle as disclosed herein includes a sound transmission analyzing unit configured to calculate an acoustic transfer function from a sound source via the air to an inner surface of a panel member on the basis of an outside-of-panel acoustic transfer function that is an acoustic transfer function involving an airborne sound from the sound source located outside the panel member of the vehicle to an outer surface of the panel member, and a panel transmission function that is an acoustic transfer function from the outer surface of the panel member to the inner surface of the panel member.

The outside-of-panel acoustic transfer function is an acoustic transfer function involving an airborne sound from the sound source to the outer surface of the panel member. The acoustic transfer function from the sound source to the inner surface of the panel member as calculated by such a configuration is an acoustic transfer function in consideration of an airborne sound that propagates through the air from the sound source and is input to the outer surface of the panel member.

According to the sound transmission analyzer for a panel member of a vehicle as disclosed herein, it is possible to obtain an acoustic transfer function involving a transmission sound transmitted through the panel member from a sound source in consideration of an airborne sound that propagates through the air from the sound source outside the panel member and is input to the outer surface of the panel member.

### BRIEF DESCRIPTION OF DRAWINGS

Embodiment(s) of the present disclosure will be described based on the following figures, wherein:

FIG. 1 is a schematic configuration diagram of a sound transmission analyzer according to a present embodiment;

FIG. 2 is a view illustrating an example of part of a body panel of a vehicle;

FIG. 3 is a conceptual diagram illustrating an airborne sound input from a sound source to an outer surface of a panel member;

FIG. 4 is a graph showing an example of the relationship between an outside-of-panel acoustic transfer function and a frequency;

FIG. 5 is a conceptual diagram illustrating a calculation image of equivalent radiated power ERP;

FIG. 6 is a conceptual diagram illustrating how a unit pressure is input to a panel member during a simulation;

FIG. 7 is a conceptual diagram illustrating a calculation image of equivalent radiated power with phase considered ERPWPC;

FIG. 8 is a graph showing an example of the relationship between ERPWPC/P² and a frequency;

FIG. 9 is a cross-sectional view of a panel member and a soundproof material;

FIG. 10 is a graph showing an example of the relationship between a soundproof material surface vibration ratio and a frequency;

FIG. 11 is a conceptual diagram illustrating an airborne sound from an inner surface of a soundproof material to a measurement position and an airborne sound from an inner surface of a panel member to the measurement position;

FIG. 12 is a graph showing an example of the relationship between an inside-of-panel acoustic transfer function and a frequency;

FIG. 13 is a graph showing the relationship between the total acoustic sensitivity and a frequency;

FIG. 14 is a graph showing the relationship between the section acoustic sensitivity of each panel section and a frequency;

FIG. 15 is a graph illustrating the relationship between the contribution of each panel section and a frequency; and

FIG. 16 is a flowchart illustrating how a sound transmission analyzer according to a present embodiment is processed.

### DESCRIPTION OF EMBODIMENTS

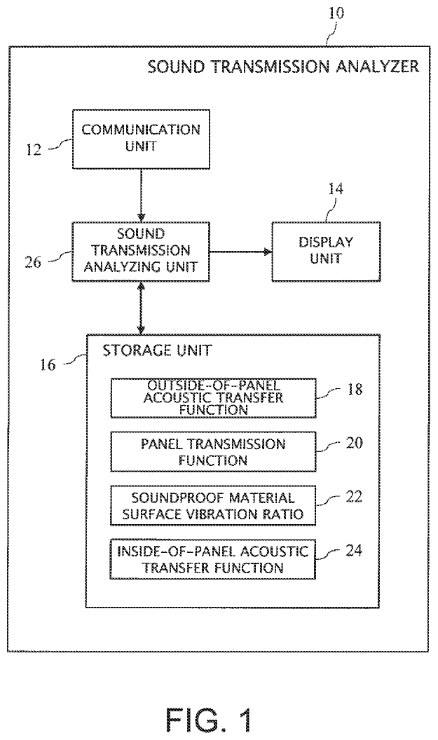

FIG. 1 is a schematic configuration diagram of a sound transmission analyzer 10 according to a present embodiment. The sound transmission analyzer 10 may be any device as long as the device implements the functions described below. For example, the sound transmission analyzer 10 used may be a server computer, a personal computer, or a portable terminal such as a tablet terminal.

The sound transmission analyzer 10 is a device for analyzing a sound emitted from a sound source located outside a body panel (on the vehicle outer side) of the vehicle and radiated through the body panel to the inner side of the body panel (on the vehicle inner side). The body panel is a component of a vehicle frame part, and is a metal part enclosing a cabin space. In the body panel, a plurality of panel sections each constituting a part of the body panel can be defined. Examples of the panel section include, but are not limited to, a cowl panel or a dash panel positioned forwardly of the cabin space, a floor panel or a tunnel panel below the cabin space, a roof panel above the cabin space, and a back panel behind the cabin space.

In particular, in this embodiment, the sound transmission analyzer 10 analyzes a sound radiated to the cabin side from an inner surface of at least one panel member while the body panel of the vehicle is conceptually divided into a plurality of panel members. As described above, the plurality of panel sections can be defined in the body panel. Each panel section conceptually includes one or more panel members.

A communication unit 12 includes, for example, a network adapter. The communication unit 12 can communicate with other devices (e.g., a user terminal used by a user, a device configured to execute a simulation that will be described later).

A display unit 14 includes, for example, a liquid crystal panel. Various screens are displayed on the display unit 14. In particular, the display unit 14 in this embodiment displays calculation results of the sound transmission analyzing unit 26 described later.

A storage unit 16 includes, for example, a hard disk drive (HDD), a solid state drive (SSD), an embedded multimedia card (eMMC), a read only memory (ROM), and/or a random access memory (RAM). The storage unit 16 is configured to store a sound transmission analysis program for causing each unit of the sound transmission analyzer 10 to function.

In addition, the storage unit 16 in this embodiment is configured to store an outside-of-panel acoustic transfer function 18, a panel transmission function 20, a soundproof material surface vibration ratio 22, and an inside-of-panel acoustic transfer function 24. Note that the outside-of-panel acoustic transfer function 18, the panel transmission function 20, the soundproof material surface vibration ratio 22, and the inside-of-panel acoustic transfer function 24 may be stored not in the storage unit 16 but in another device accessible from the sound transmission analyzer 10.

The outside-of-panel acoustic transfer function 18, the panel transmission function 20, the soundproof material surface vibration ratio 22, and the inside-of-panel acoustic transfer function 24 are acquired by actual measurement or simulation for each panel member obtained by conceptually dividing the body panel of the vehicle. Note that in the case of acquisition by simulation, the simulation may be executed by the sound transmission analyzer 10 or may be executed by a device other than the sound transmission analyzer 10.

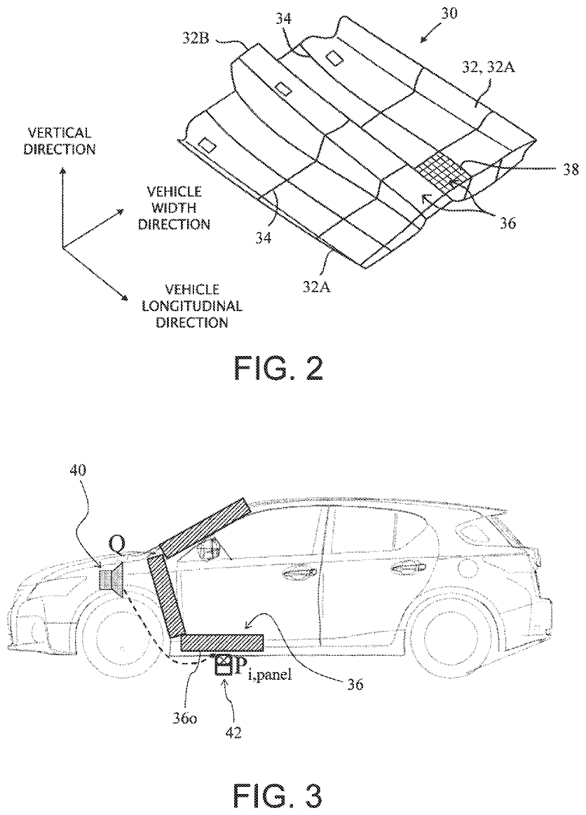

Before describing the outside-of-panel acoustic transfer function 18, the panel transmission function 20, the soundproof material surface vibration ratio 22, and the inside-of-panel acoustic transfer function 24, the panel member(s) will be described. FIG. 2 is a diagram illustrating an example of part of the body panel 30 of the vehicle. As described above, a plurality of panel sections 32 can be defined in the body panel 30 of the vehicle. FIG. 2 illustrates part of a floor panel 32A and part of a tunnel panel 32B among the panel sections 32.

As illustrated in FIG. 2, the body panel 30 is conceptually divided into a plurality of panel members 36 by each division line 34. In the example of FIG. 2, the floor panel 30A and the tunnel panel 30B are each divided into a plurality of panel members 36, but one panel section 32 may be made up of one panel member 36. The body panel 30 is divided (in other words, the definition of the division line 34) by software called a mesher executed by the sound transmission analyzer 10 or another device. Specifically, 3D data about the body panel 30 created in advance is read into the mesher, and each division line 34 is defined by user operation or automatically by the mesher. Each panel member 36 obtained by the mesher is provided with a panel ID for uniquely identifying the panel member 36 and a section ID indicating a panel section 32 to which the panel member belongs. This makes it possible to identify each panel member 36 by computer-aided engineering (CAE), which is software used to execute a simulation for acquiring the outside-of-panel acoustic transfer function 18, the panel transmission function 20, the soundproof material surface vibration ratio 22, and the inside-of-panel acoustic transfer function 24, or by the sound transmission analyzing unit 26 described later. It is also possible to identify the panel section 32 to which each panel member 36 belongs.

In addition, each panel member 36 is divided into elements 38 that are smaller sub-regions (in FIG. 2, elements 38 are shown for just one panel member 36). The elements 38 may also be defined by the mesher. Usage of the elements 38 will be described later together with the description of the panel transmission function 20.

The area of each panel member 36 is set according to the frequency or wavelength of a sound to be analyzed. Specifically, the area of each panel member 36 is set such that the wavelength of a sound to be analyzed is sufficiently smaller than the area of the panel member 36. More specifically, the area of each panel member 36 is set such that the area of the panel member 36 includes at least one wavelength of a sound to be analyzed. For example, if the sound to be analyzed has a frequency in a medium region (from 200 to 630 [Hz]), the area of each panel member 36 is set to 300×300 [mm] or larger.

Hereinafter, the outside-of-panel acoustic transfer function 18, the panel transmission function 20, the soundproof material surface vibration ratio 22, and the inside-of-panel acoustic transfer function 24 will be described.

The outside-of-panel acoustic transfer function 18 is an acoustic transfer function involving an airborne sound that is a sound propagating through the air from a sound source outside the body panel 30 (i.e., the panel member 36) to an outer surface of the panel member 36. The outside-of-panel acoustic transfer function 18 will be described with reference to FIG. 3.

FIG. 3 is a conceptual diagram illustrating an airborne sound input from a sound source outside the panel member 36 to an outer surface 36o of the panel member 36. In a case where the outside-of-panel acoustic transfer function 18 is acquired by actual measurement, a speaker 40 is installed at the position of the sound source, and a microphone 42 is installed in the vicinity of the outer surface 36o of the panel member 36. Note that in this embodiment, since an engine is assumed to be the sound source, the speaker 40 is disposed at the position of the engine. In FIG. 3, the dashed line extending from the speaker 40 to the panel member 36 represents an airborne sound.

Then, the volume velocity Q of the speaker 40, and the sound pressure P_{i,panel} of a sound acquired by the microphone 42 when the sound is output from the speaker 40, are acquired. The volume velocity Q of the speaker 40 is the product of the area of cone portion, which is a vibration part of the speaker 40, and the vibration velocity, and means that the larger the value, the louder the sound. The outside-of-panel acoustic transfer function 18 is expressed by a ratio between the volume velocity Q of the speaker 40 and the sound pressure P_{i,panel} at the microphone 42, that is, P_{i,panel}/Q [dB]. The subscript i indicates a panel member 36. The outside-of-panel acoustic transfer function 18 is obtained for each panel member 36.

It can be said that the outside-of-panel acoustic transfer function 18 is an indicator that indicates how easily a sound in the air is transmitted from the sound source to the outer surface 36o of the panel member 36. As the outside-of-panel acoustic transfer function 18 becomes larger, the sound from the sound source is more readily transmitted to the outer surface 36o of the panel member 36. On the other hand, as the outside-of-panel acoustic transfer function 18 becomes smaller, the sound from the sound source is less readily transmitted to the outer surface 36o of the panel member 36.

The outside-of-panel acoustic transfer function 18 for each panel member 36 can also be acquired by simulation using CAE. Specifically, 3D data about the body panel 30 divided by the mesher is read into the CAE. Then, the CAE is used to simulate installation of the speaker 40 at the sound source position, installation of the microphone 42 in the vicinity of the outer surface 36o of the panel member 36, measurement of the volume velocity Q of the speaker 40, and the sound pressure P_{i,panel} of the sound acquired by the microphone 42.

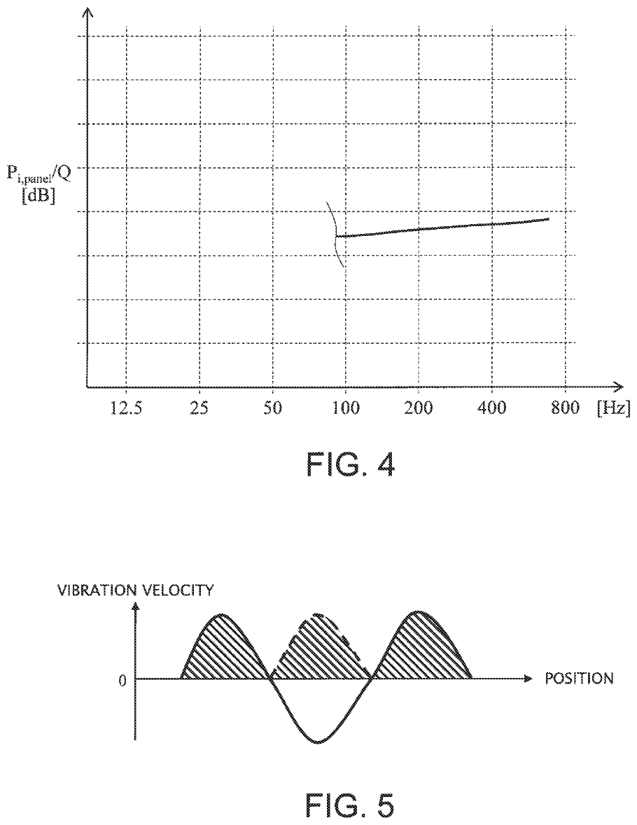

FIG. 4 is a graph illustrating an example of the relationship between the outside-of-panel acoustic transfer function 18 and a frequency. In the graph, the ordinate represents the outside-of-panel acoustic transfer function 18, and the abscissa represents the frequency. This graph shows the outside-of-panel acoustic transfer function 18 for one panel member 36. The sound output from the speaker 40 includes sounds with various frequencies, and the sound acquired by the microphone 42 also includes sounds with various frequencies. Thus, the outside-of-panel acoustic transfer function 18 is obtained for each frequency. As a result, for each panel member 36, a graph illustrating the relationship between the outside-of-panel acoustic transfer function 18 and the frequency as illustrated in FIG. 4 is acquired.

The panel transmission function 20 is an acoustic transfer function from the outer surface 36o of the panel member 36 to the inner surface of the panel member 36. Since the panel transmission function 20 is obtained based on equivalent radiated power representing the amount of acoustic energy radiated from the panel member 36, the transmitted radiation power will first be described.

The equivalent radiated power ERP is calculated by the following Formula 1.

$$ERP = \frac{1}{2} {ρ}_{0} {c}_{0} σ {\sum }_{j = 1}^{N} ( {V}_{j} \cdot {\overline{V}}_{j} \cdot {S}_{j} ) \qquad ( Formula 1 )$$

In Formula 1, ρ₀ represents the density of air, c₀ represents the speed of sound, σ represents a radiation attenuation coefficient, variable j represents each element 38 defined in the panel member 36 for which the panel transmission function 20 is calculated, N represents the number of elements 38 in the panel member 36, and Vⱼ represents the vibration velocity of each element 38, in particular, the speed in the normal direction of the panel member 36,

### V̅ⱼ

represents the conjugate complex number of the vibration velocity Vⱼ of each element 38, and Sⱼ represents the area of each element 38.

The radiation attenuation coefficient σ is an indicator that represents the efficiency of converting the vibration of the panel member 36 into sound. For example, depending on a situation around the panel member 36 (e.g., a positional relationship with other members), there may be a situation where it is difficult to convert the vibration of the panel member 36 into sound. In this case, by inputting a value for the radiation attenuation coefficient σ, it is possible to obtain equivalent radiated power ERP in consideration of the efficiency of converting the vibration of the panel member 36 into sound. In the case without considering the efficiency of converting the vibration of the panel member 36 to sound, the radiation attenuation coefficient σ for every panel member 36 is set to 1.

The product of the vibration velocity Vⱼ and its conjugate complex number is the square of the vibration velocity Vⱼ of the element 38 in the panel member 36 when the phase is not considered. Thus,

(Vⱼ·V̅ⱼ·Sⱼ)
is the product of the square of the vibration velocity Vⱼ of an element 38 without phase considered and the area of the element 38. Thus, it can be said that the equivalent radiated power ERP is calculated based on a value obtained by totaling the product of the square of the vibration velocity Vⱼ without phase considered and the area Sⱼ for each element 38 included in the panel member 36.

FIG. 5 shows a calculation image of the equivalent radiated power ERP. In FIG. 5, the abscissa represents a physical position (which may be referred to as an element 38) on the panel member 36, and the ordinate represents a vibration velocity. In the equivalent radiated power ERP, the phase of the vibration velocity Vⱼ of each element 38 is not considered as described above. Thus, if the vibration velocity Vⱼ is negative (when speed in the outward direction occurs), the vibration velocity is inverted to a positive value as indicated by the dashed line in FIG. 5. Then, the equivalent radiated power ERP is calculated. Note that hatched portions in FIG. 5 represent portions considered as equivalent radiated power ERP.

As described above, the equivalent radiated power ERP is calculated based on the vibration velocity Vⱼ of each element 38 constituting the panel member 36, and the vibration velocity Vⱼ of each element 38 is obtained by simulation in CAE.

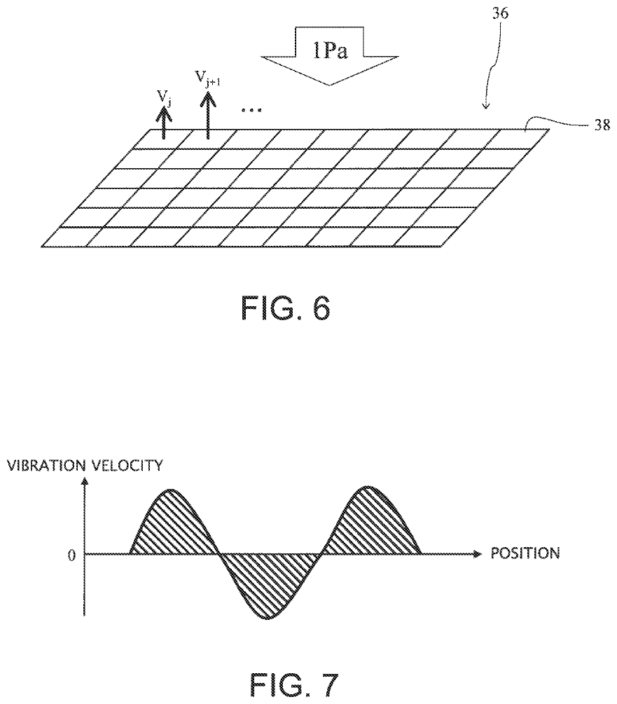

FIG. 6 is a diagram schematically illustrating the panel member 36 and a plurality of elements 38 constituting the panel member 36. In the simulation, first, a sound pressure of 1 [Pa (Pascal)] is input to the panel member 36. Here, 1 [Pa] is a pressure at which a force of 1 [N (Newton)] is applied per area of 1 square meter (m²). For example, when the area of the panel member 36 is 0.6 [m²], a sound pressure of 0.6 [N] is applied to the panel member 36.

The CAE is used to simulate vibration of each element 38 when a sound pressure of 1 [Pa] is applied to the panel member 36. Then, the vibration velocity Vⱼ of each element 38 is acquired. Note that the vibration velocity Vⱼ of each element 38 included in the panel member 36 can be different depending on factors such as the structure of the panel member 36. For example, as shown in FIG. 6, the vibration velocity Vⱼ of one element 38 and the vibration velocity Vⱼ₊₁ of another element 38 may be different speeds from each other. As described above, in this embodiment, the vibration velocity Vⱼ of each element 38 constituting the panel member 36 when a force of 1 [Pa] is input to the panel member 36 is acquired.

As is clear from Formula 1, the equivalent radiated power ERP is a value that varies depending on the vibration velocity Vⱼ of each element 38 (which may be referred to as a sound pressure input to the panel member 36). Specifically, as the velocity Vⱼ increases, the equivalent radiated power ERP also increases. Thus, the equivalent radiated power ERP does not by itself represent the panel transmission function 20 of the panel member 36.

The equivalent radiated power ERP is set to a value that does not depend on the vibration velocity Vⱼ of each element 38 (that is, the sound pressure input to the panel member 36). To achieve this, as shown in the following Formula 2, the vibration velocity Vⱼ and its conjugate complex number on the right side of Formula 1 are each divided by the sound pressure input to the panel member 36, namely, P_{i,panel}.

$$\frac{1}{2} {ρ}_{0} {c}_{0} σ {\sum }_{j = 1}^{N} ( \frac{{V}_{j}}{{P}_{i , panel}} \cdot \frac{{\overline{V}}_{j}}{{P}_{i , panel}} \cdot {S}_{j} ) \qquad ( Formula 2 )$$

The parameter represented by Formula 2 represents the amount of acoustic energy radiated from the panel member 36 when the sound pressure P_{i,panel} is input to the outer surface 36o of the panel member 36 (in other words, when the sound pressure P_{i,panel} is provided as input conditions). That is, the parameter represented by Formula 2 is the acoustic transfer function from the outer surface 36o of the panel member 36 to the inner surface of the panel member 36, namely, the panel transmission function 20. As used herein, the panel transmission function 20 is denoted as τ_{i,panel}. Formula 2 may be converted to express τ_{i,panel} by the following Formula 3.

$${τ}_{i , panel} = \frac{2 {ρ}_{0} {c}_{0} ERPC}{{P}_{i , panel}^{2} S} \qquad ( Formula 3 )$$

As described above, the panel transmission function 20 is calculated for each panel member 36. As the panel transmission function 20 becomes larger, the sound from the outer surface 36o of the panel member 36 is more readily transmitted to the inner surface 36i of the panel member 36. On the other hand, as the panel transmission function 20 becomes smaller, the sound from the outer surface 36o of the panel member 36 is less readily transmitted to the inner surface 36i of the panel member 36.

As described above, the equivalent radiated power ERP is calculated based on the vibration velocity Vⱼ while the phase of the element 38 is not considered. However, the amount of acoustic energy radiated from the panel member 36 by the vibration of each element 38 is more suitably calculated while the phase of the vibration velocity Vⱼ is considered. Specifically, the phase of the vibration velocity Vⱼ is sometimes not considered. In this case, if the vibration velocity Vⱼ is negative as illustrated in FIG. 5, the equivalent radiated power ERP is calculated while the vibration velocity Vⱼ is assumed to be positive. Thus, the calculated equivalent radiated power ERP may indicate an energy amount larger than an actual energy amount.

Thus, the panel transmission function 20 may be acquired based on, instead of the equivalent radiated power ERP, the equivalent radiated power with phase considered ERPWPC in which the phase of the vibration velocity Vⱼ is considered.

The equivalent radiated power with phase considered ERPWPC is calculated by Formula 4 below.

$$ERPWPC = \frac{1}{2} {ρ}_{0} {c}_{0} σ \frac{{\vert {\sum }_{j = 1}^{N} ( {V}_{j} \cdot {S}_{j} ) \vert}^{2}}{{\sum }_{j = 1}^{N} ( Sj )} \qquad ( Formula 4 )$$

As shown in Formula 4, in the equivalent radiated power with phase considered ERPWPC, the product of the vibration velocity Vⱼ and the area Sⱼ for each element 38 is summed, and the absolute value of the sum is squared (the numerator on the right side of Formula 4). The reason why the sum is squared is because the equivalent radiated power ERP is expressed including the square of the vibration velocity Vⱼ. When the sum of the products of the vibration velocity Vⱼ and the area Sⱼ is squared, the sum of the areas Sⱼ of the respective elements 38 is also squared. Accordingly, the square of the sum of the products of the vibration velocity Vⱼ and the area Sⱼ is divided by the sum of the areas Sⱼ of the respective elements 38 (the denominator on the right side of Formula 4).

In Formula 4, since the vibration velocities Vⱼ of the plurality of elements 38 are added as they are, the equivalent radiated power in which the phase of the vibration velocity Vⱼ is considered, that is, the equivalent radiated power with phase considered ERPWPC, can be calculated according to Formula 4.

FIG. 7 shows a calculation image of the equivalent radiated power with phase considered ERPWPC. Also, in FIG. 7, as in FIG. 5, the abscissa represents a physical position on the panel member 36, and the ordinate represents a velocity. In the equivalent radiated power with phase considered ERPWPC according to Formula 4, the phase of the velocity Vⱼ of each element 38 is considered as described above. Thus, the regions indicated by the hatched portions in FIG. 7 are considered as the equivalent radiated power with phase considered ERPWPC.

If the panel transmission function 20 is acquired based on the equivalent radiated power with phase considered ERPWPC, τ_{i,panel} can be expressed by Formula 5 below.

$${τ}_{i , panel} = \frac{2 {ρ}_{0} {c}_{0} ERPWPC}{{P}_{i , panel}^{2} S} \qquad ( Formula 5 )$$

In the following description, it is assumed that the panel transmission function 20 is calculated based on the equivalent radiated power with phase considered ERPWPC.

FIG. 8 is a graph showing an example of the relationship between ERPWPC/P² and a frequency, and this relationship is used to calculate the panel transmission function 20. In the graph, the ordinate represents ERPWPC/P², and the abscissa represents a frequency. This graph shows ERPWPC/P² for one panel member 36. In the simulation, ERPWPC/P² at each frequency is acquired by inputting sounds with various frequencies to the panel member 36. As a result, for each panel member 36, a graph showing the relationship between the ERPWPC/P² and a frequency as illustrated in FIG. 8 is acquired.

The soundproof material surface vibration ratio 22 is a ratio between a vibration velocity V_{i,panel} in the normal direction of the panel member 36 and a vibration velocity V_{i,trim} in the normal direction of a surface (inner surface) of the soundproof material provided on the inner side of the panel member 36.

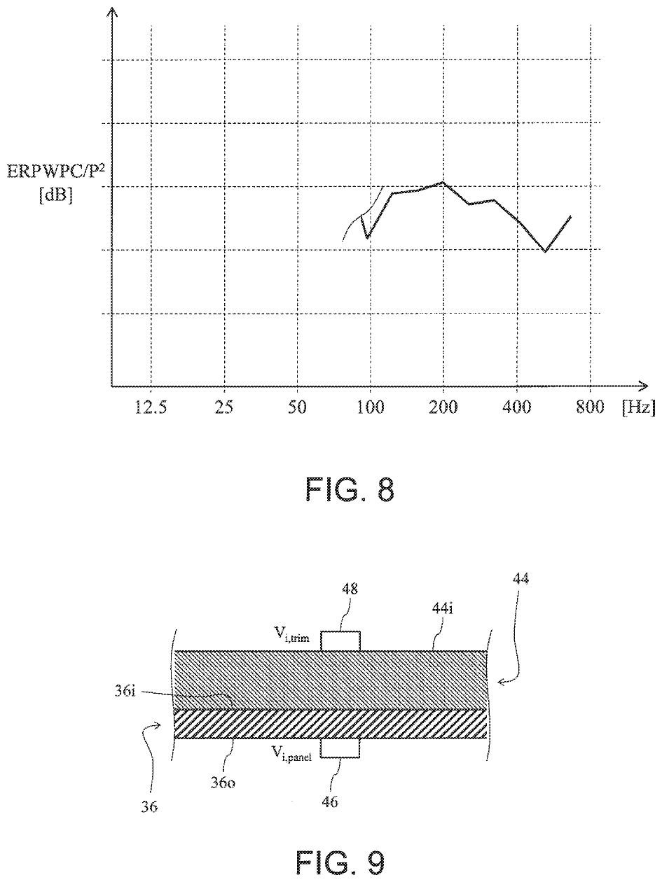

FIG. 9 is a cross-sectional view of the panel member 36 and the soundproof material 44. As illustrated in FIG. 9, a soundproof material 44 formed of, for example, felt may be provided on the inner side of the panel member 36. When the soundproof material 44 is provided, a sound input to the panel member 36 is attenuated by the soundproof material 44, and the attenuated sound is radiated from the inner surface of the soundproof material 44. The soundproof material surface vibration ratio 22 is a parameter in consideration of the effect of the soundproof material 44.

When the soundproof material surface vibration ratio 22 is acquired by actual measurement, an accelerometer 46 is attached to the outer surface 36o of the panel member 36, and an accelerometer 48 is provided on the inner surface 44i of the soundproof material 44. Then, the vibration velocity V_{i,panel} of the outer surface 36o of the panel member 36 is calculated by time-integrating the acceleration at the panel member 36 as measured by the accelerometer 46, and the vibration velocity V_{i,trim} of the inner surface 44i of the soundproof material 44 is calculated by time-integrating the acceleration at the inner surface 44i of the soundproof material 44 as measured by the accelerometer 48. Note that since the panel member 36 can be regarded as a rigid body, the vibration velocities of the outer surface 36o and the inner surface 36i can be regarded as the same.

The soundproof material surface vibration ratio 22 is expressed by the square of the ratio between the vibration velocity V_{i,panel} of the panel member 36 and the vibration velocity V_{i,trim} of the inner surface 44i of the soundproof material 44. As used herein, the soundproof material surface vibration ratio 22 is described as T_{i,trim}. T_{i,trim} is expressed by the following Formula 6.

$${τ}_{i , trim} = {( \frac{{V}_{i , trim}}{{V}_{i , panel}} )}^{2} \qquad ( Formula 6 )$$

As described above, the soundproof material surface vibration ratio 22 is acquired for each panel member 36. As a matter of course, the soundproof material surface vibration ratio 22 is not acquired for the panel member 36 that does not have the soundproof material 44 provided on the inner side.

The soundproof material surface vibration ratio 22 for each panel member 36 can also be acquired by simulation using CAE. Specifically, 3D data about the body panel 30 divided by the mesher is read into the CAE. The panel member 36 is vibrated in simulation. Then, measurement of the vibration velocity V_{i,panel} of the outer surface 36o of each panel member 36 and measurement of the vibration velocity V_{i,trim} of the inner surface 44i of the soundproof material 44 provided on the inner side of each panel member 36 are simulated on the CAE.

It can be said that the soundproof material surface vibration ratio 22 is an acoustic transfer function from the inner surface 36i of the panel member 36 to the inner surface 44i of the soundproof material 44. As the soundproof material surface vibration ratio 22 becomes larger, the sound from the inner surface 36i of the panel member 36 is more readily transmitted to the inner surface 44i of the soundproof material 44. On the other hand, as the soundproof material surface vibration ratio 22 becomes smaller, the sound from the inner surface 36i of the panel member 36 is less readily transmitted to the inner surface 44i of the soundproof material 44.

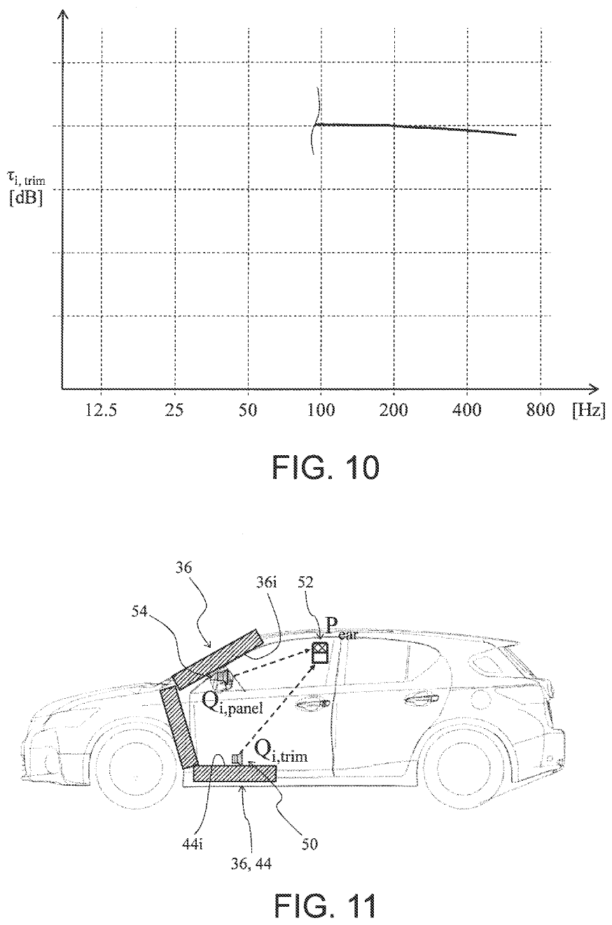

FIG. 10 is a graph showing an example of the relationship between the soundproof material surface vibration ratio 22 and a frequency. In this graph, the ordinate is a transmittance [dB] represented on a logarithmic scale, and the abscissa represents a frequency. The graph shows the soundproof material surface vibration ratio 22 for one panel member 36. The vibration mode of the panel member 36 or the inner surface 44i of the soundproof material 44 includes vibrations with various frequencies. Thus, the soundproof material surface vibration ratio 22 is obtained for each frequency. As a result, a graph showing the relationship between the soundproof material surface vibration ratio 22 and the frequency as shown in FIG. 10 is acquired for each panel member 36.

The inside-of-panel acoustic transfer function 24 is an acoustic transfer function involving an airborne sound from the inner surface 44i of the soundproof material 44 to a measurement position (inside the cabin) on the inner side of the panel member 36. Alternatively, the inside-of-panel acoustic transfer function 24 is an acoustic transfer function involving an airborne sound from the inner surface 36i of the panel member 36 to a measurement position on the inner side of the panel member 36. The inside-of-panel acoustic transfer function 24 will be described with reference to FIG. 11.

FIG. 11 is a conceptual diagram illustrating an airborne sound input to a measurement position from the inner surface 44i of the soundproof material 44 and an airborne sound input to the measurement position from the inner surface 36i of the panel member 36. The measurement position may be set to be on the inner side of the panel member 36, for example, in the cabin space, as appropriate. For example, the measurement position is set at the position of an ear of an occupant sitting on a seat (in front of a headrest of the seat). In a case where the inside-of-panel acoustic transfer function 24 is acquired by actual measurement, a speaker 50 is installed near the inner surface 44i of the soundproof material 44, and a microphone 52 is installed at the measurement position. In FIG. 11, a dashed line extending from the speaker 50 to the measurement position denotes an airborne sound.

Then, the volume velocity Q_{i,trim} of the speaker 50 when the sound is output from the speaker 50, and the sound pressure Pₑₐᵣ of the sound obtained by the microphone 52, are acquired. The inside-of-panel acoustic transfer function 24 is expressed by a ratio between the volume velocity Q_{i,trim} at the speaker 50 and the sound pressure Pₑₐᵣ at the microphone 52, namely, Pₑₐᵣ/Q_{i,trim} [dB].

It can be said that the inside-of-panel acoustic transfer function 24 is an indicator that indicates how easily an airborne sound is transmitted from the inner surface 44i of the soundproof material 44 to the measurement position. As the inside-of-panel acoustic transfer function 24 becomes larger, the sound from the inner surface 44i of the soundproof material 44 is more readily transmitted to the measurement position. As the inside-of-panel acoustic transfer function 24 becomes smaller, the sound from the inner surface 44i of the soundproof material 44 is less readily transmitted to the measurement position.

The inside-of-panel acoustic transfer function 24 is calculated for each panel member 36.

For the panel member 36 provided with the soundproof material 44, as described above, Pₑₐᵣ/Q_{i,trim} is calculated as the first inside-of-panel acoustic transfer function. However, for the panel member 36 with which the soundproof material 44 is not provided, the acoustic transfer function involving an airborne sound from the inner surface 36i of the panel member 36 to the measurement position is calculated as the second inside-of-panel acoustic transfer function. Specifically, the speaker 54 is installed near the inner surface 36i of the panel member 36, and the microphone 52 is installed at the measurement position. Then, the volume velocity Q_{i,panel} at the speaker 54 when the sound is output from the speaker 54, and the sound pressure Pₑₐᵣ of the sound obtained with the microphone 52, are acquired. In this case, the inside-of-panel acoustic transfer function 24 is expressed by a ratio between the volume velocity Q_{i,panel} at the speaker 54 and the sound pressure Pₑₐᵣ at the microphone 52, namely, Pₑₐᵣ/Q_{i,panel} [dB].

The inside-of-panel acoustic transfer function 24 for each panel member 36 can also be acquired by simulation using CAE. Specifically, 3D data about the body panel 30 divided by the mesher is read into the CAE. Installation of the speaker 54 or 50 in the vicinity of the inner surface 44i of the soundproof material 44 (or the inner surface 36i of the panel member 36), installation of the microphone 52 at the sound source position, measurement of the volume velocity Q_{i,trim} (or Q_{i,panel}) at the speaker 50, and measurement of the sound pressure Pₑₐᵣ at the microphone 52 are simulated on the CAE.

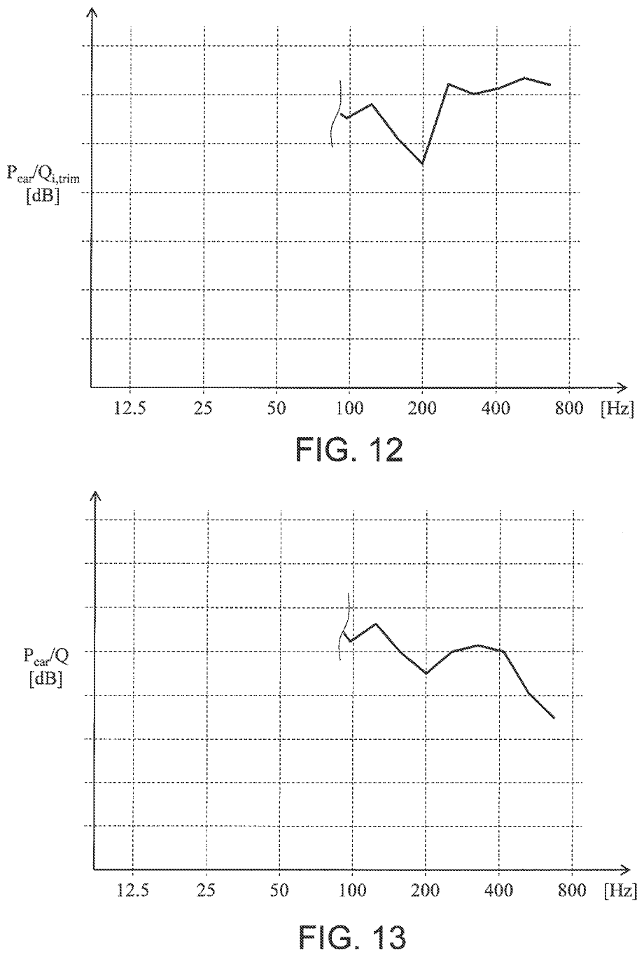

FIG. 12 is a graph showing an example of the relationship between the inside-of-panel acoustic transfer function 24 and a frequency. In the graph, the ordinate represents the inside-of-panel acoustic transfer function 24, and the abscissa represents the frequency. This graph shows the inside-of-panel acoustic transfer function 24 for one panel member 36. The sound output from the speaker 50 or 54 includes sounds with various frequencies, and the sound acquired by the microphone 52 also includes sounds with various frequencies. Thus, the inside-of-panel acoustic transfer function 24 is obtained for each frequency. As a result, for each panel member 36, a graph illustrating the relationship between the inside-of-panel acoustic transfer function 24 and the frequency as illustrated in FIG. 12 is acquired.

Back to FIG. 1. The sound transmission analyzing unit 26 is realized by, for example, cooperation between a processor such as a central processing unit (CPU), an application specific integrated circuit (ASIC), or a field-programmable gate array (FPGA) and a sound transmission analyzing program stored in the storage unit 16.

The sound transmission analyzing unit 26 is configured to be able to calculate, based on the outside-of-panel acoustic transfer function 18 and the panel transmission function 20, an acoustic transfer function from the sound source via the air to the inner surface 36i of a specific panel member 36. As described above, the outside-of-panel acoustic transfer function 18 is an acoustic transfer function involving an airborne sound from the sound source to the outer surface 36o of the panel member 36. The panel transmission function 20 is an acoustic transfer function from the outer surface 36o of the panel member 36 to the inner surface 36i of the panel member 36. Thus, the outside-of-panel acoustic transfer function 18 and the panel transmission function 20 may be used in combination to give an acoustic transfer function from the sound source via the air to the inner surface 36i of a specific panel member 36. As the acoustic transfer function becomes larger, the sound from the sound source is more readily transmitted to the inner surface 36i of the panel member 36. On the other hand, as the acoustic transfer function becomes smaller, the sound from the sound source is less readily transmitted to the inner surface 36i of the panel member 36.

The acoustic transfer function from the sound source via the air to the inner surface 36i of the specific panel member 36 can be expressed by Formula 7 below.

$$\frac{{P}_{i , panel}}{Q} \times {τ}_{i , panel} = \frac{{P}_{i , panel}}{Q} \times \frac{2 {ρ}_{0} {c}_{0} ERPWPC}{{P}_{i , panel}^{2} S} \qquad ( Formula 7 )$$

That is, the acoustic transfer function from the sound source via the air to the inner surface 36i of the specific panel member 36 is expressed by the product of the outside-of-panel acoustic transfer function 18 and the panel transmission function 20.

As illustrated in FIGS. 4 and 8, the outside-of-panel acoustic transfer function 18 and the panel transmission function 20 are obtained for each frequency. Thus, the sound transmission analyzing unit 26 obtains the acoustic transfer function from the sound source via the air to the inner surface 36i of the specific panel member 36 for each frequency by obtaining the product of the outside-of-panel acoustic transfer function 18 and the panel transmission function 20 for each frequency. The sound transmission analyzing unit 26 can generate a graph indicating the relationship between the acoustic transfer function and the frequency. This graph is provided to a user by, for example, being transmitted from the communication unit 12 to a user terminal or being displayed on the display unit 14. As a result, the user can evaluate how much the sound at each frequency, as emitted from the sound source, propagated through the air, and input to the panel member 36, is transmitted to the inner surface 36i of the specific panel member 36.

In addition, the sound transmission analyzing unit 26 can calculate, based on the outside-of-panel acoustic transfer function 18, the panel transmission function 20, and the soundproof material surface vibration ratio 22, an acoustic transfer function from the sound source via the air and the specific panel member 36 to the inner surface 44i of the soundproof material 44 provided on the inner side of the panel member 36. As described above, the soundproof material surface vibration ratio 22 is an acoustic transfer function from the inner surface 36i of the panel member 36 to the inner surface 44i of the soundproof material 44. Thus, the outside-of-panel acoustic transfer function 18, the panel transmission function 20, and the soundproof material surface vibration ratio 22 may be used in combination to give an acoustic transfer function from the sound source, via the air and the specific panel member 36, to the inner surface 44i of the soundproof material 44. As the acoustic transfer function becomes larger, the sound from the sound source is more readily transmitted to the inner surface 44i of the soundproof material 44. On the other hand, as the acoustic transfer function becomes smaller, the sound from the sound source is less readily transmitted to the inner surface 44i of the soundproof material 44.

The acoustic transfer function from the sound source via the air and the specific panel member 36 to the inner surface 44i of the soundproof material 44 can be expressed by Formula 8 below.

$$\frac{{P}_{i , panel}}{Q} \times {τ}_{i , panel} \times {τ}_{i , trim} = \frac{{P}_{i , panel}}{Q} \times \frac{2 {ρ}_{0} {c}_{0} ERPWPC}{{P}_{i , panel}^{2} S} \times {( \frac{{V}_{i , trim}}{{V}_{i , panel}} )}^{2} \qquad ( Formula 8 )$$

That is, the acoustic transfer function from the sound source via the air and the specific panel member 36 to the inner surface 44i of the soundproof material 44 is expressed by the product of the outside-of-panel acoustic transfer function 18, the panel transmission function 20, and the soundproof material surface vibration ratio 22.

In addition to the outside-of-panel acoustic transfer function 18 and the panel transmission function 20, the soundproof material surface vibration ratio 22 is also acquired for each frequency as shown in FIG. 10. Thus, the sound transmission analyzing unit 26 obtains the acoustic transfer function from the sound source, via the air and the specific panel member 36, to the inner surface 44i of the soundproof material 44 for each frequency by obtaining the product of the outside-of-panel acoustic transfer function 18, the panel transmission function 20, and the soundproof material surface vibration ratio 22 for each frequency. The sound transmission analyzing unit 26 can generate a graph indicating the relationship between the acoustic transfer function and the frequency. The graph is also provided to a user. As a result, the user can evaluate how much the sound at each frequency emitted from the sound source, propagated through the air, and input to the panel member 36 is transmitted to the inner surface 44i of the soundproof material 44 for the specific panel member 36.

In addition, the sound transmission analyzing unit 26 can calculate, based on the outside-of-panel acoustic transfer function 18, the panel transmission function 20, the soundproof material surface vibration ratio 22, and the inside-of-panel acoustic transfer function 24, an acoustic sensitivity P_{i,ear}/Q, that is, an acoustic transfer function from the sound source, via the air, the specific panel member 36, and the soundproof material 44 provided on the inner side of the panel member 36, to the measurement position. As mentioned above, the inside-of-panel acoustic transfer function 24 (in this case, the first inside-of-panel acoustic transfer function Pₑₐᵣ/Q_{i,trim}) is an acoustic transfer function involving an airborne sound from the inner surface 44i of the soundproof material 44 to the measurement position. Thus, the outside-of-panel acoustic transfer function 18, the panel transmission function 20, the soundproof material surface vibration ratio 22, and the inside-of-panel acoustic transfer function 24 may be used in combination to give the acoustic sensitivity P_{i,ear}/Q. As the acoustic sensitivity P_{i,ear}/Q becomes larger, the sound from the sound source is more readily transmitted to the measurement position. On the other hand, as the acoustic sensitivity P_{i,ear}/Q becomes smaller, the sound from the sound source is less readily transmitted to the measurement position.

The acoustic sensitivity P_{i,ear}/Q can be expressed by the following Formula 9.

$$\begin{matrix}\frac{{P}_{i , ear}}{Q} = \frac{{P}_{i , panel}}{Q} \times {τ}_{i , panel} \times {τ}_{i , trim} \times \frac{{P}_{ear}}{{P}_{i , trim}} \\ = \frac{{P}_{i , panel}}{Q} \times \frac{2 {ρ}_{0} {c}_{0} ERPWPC}{{P}_{i , panel}^{2} S} \times {( \frac{{V}_{i , trim}}{{V}_{i , panel}} )}^{2} \times \frac{{P}_{ear}}{{P}_{i , trim}} \\ = \frac{{P}_{i , panel}}{Q} \times \frac{ERPWPC}{{P}_{i , panel}^{2}} \times {( \frac{{V}_{i , trim}}{{V}_{i , panel}} )}^{2} \times \frac{{P}_{ear}}{{Q}_{i , trim}}\end{matrix} \qquad ( Formula 9 )$$

That is, the acoustic sensitivity P_{i,ear}/Q is expressed by the product of the outside-of-panel acoustic transfer function 18, the panel transmission function 20, the soundproof material surface vibration ratio 22, and the inside-of-panel acoustic transfer function 24.

Note that in the upper and middle expressions of Formula 9, the inside-of-panel acoustic transfer function 24 is expressed by Pₑₐᵣ/P_{i,trim}. Meanwhile, in the lower expression of Formula 9, 2ρ₀c₀/S=P/Q. Thus, the panel transmission function 20 is expressed by ERPWPC/P_{i,panel}², and the inside-of-panel acoustic transfer function 24 is expressed by Pₑₐᵣ/Q_{i,trim}.

In addition to the outside-of-panel acoustic transfer function 18, the panel transmission function 20, and the soundproof material surface vibration ratio 22, the inside-of-panel acoustic transfer function 24 is also acquired for each frequency as illustrated in FIG. 12. Thus, the sound transmission analyzing unit 26 obtains the acoustic sensitivity P_{i,ear}/Q (acoustic sensitivity P_{i,ear}/Q, namely an acoustic transfer function from the sound source via the air, the specific panel member 36, and the soundproof material 44 to the measurement position) for a specific panel member 36 by the product of the outside-of-panel acoustic transfer function 18, the panel transmission function 20, the soundproof material surface vibration ratio 22, and the inside-of-panel acoustic transfer function 24 for each frequency. The sound transmission analyzing unit 26 can generate a graph indicating the relationship between the acoustic sensitivity and the frequency. The graph is also provided to a user. As a result, the user can evaluate how much the sound at each frequency as emitted from the sound source is transmitted via the air, the specific panel member 36, and the soundproof material 44 to the measurement position.

For the panel member 36 with which the soundproof material 44 is not provided, the sound transmission analyzing unit 26 can calculate, based on the outside-of-panel acoustic transfer function 18, the panel transmission function 20, and the inside-of-panel acoustic transfer function 24 (in this case, the second inside-of-panel acoustic transfer function Pₑₐᵣ/Q_{i,panel}), the acoustic sensitivity from the sound source via the air and the specific panel member 36 to the measurement position. The acoustic sensitivity P_{i,ear}/Q in this case can be expressed by the following Formula 10.

$$\begin{matrix}\frac{{P}_{i , ear}}{Q} = \frac{{P}_{i , panel}}{Q} \times {τ}_{i , panel} \times \frac{{P}_{ear}}{{P}_{i , panel}} \\ = \frac{{P}_{i , panel}}{Q} \times \frac{2 {ρ}_{0} {c}_{0} ERPWPC}{{P}_{i , panel}^{2} S} \times \frac{{P}_{ear}}{{P}_{i , panel}} \\ = \frac{{P}_{i , panel}}{Q} \times \frac{ERPWPC}{{P}_{i , panel}^{2}} \times \frac{{P}_{ear}}{{Q}_{i , panel}}\end{matrix} \qquad ( Formula 10 )$$

In addition, the sound transmission analyzing unit 26 can obtain, by totaling the acoustic sensitivities P_{i,ear}/Q for a plurality of the panel members 36, the total acoustic sensitivity Pₑₐᵣ/Q, which is an acoustic transfer function from the sound source to the measurement position in consideration of a plurality of acoustic transfer paths from the sound source via the air and each panel member 36 to the measurement position. Specifically, the sound transmission analyzing unit 26 can obtain the total acoustic sensitivity Pₑₐᵣ/Q by totaling the products of the outside-of-panel acoustic transfer function 18, the panel transmission function 20, the soundproof material surface vibration ratio 22, and the inside-of-panel acoustic transfer function 24 for each panel member 36. As the total acoustic sensitivity Pₑₐᵣ/Q becomes larger, the sound from the sound source is more readily transmitted to the measurement position. On the other hand, as the total acoustic sensitivity Pₑₐᵣ/Q becomes smaller, the sound from the sound source is less readily transmitted to the measurement position.

The total acoustic sensitivity Pₑₐᵣ/Q can be expressed by the following Formula 11.

$$\begin{matrix}\frac{{P}_{ear}}{Q} = {\sum }_{i = 1}^{M} ( \frac{{P}_{i , ear}}{Q} ) \\ = {\sum }_{i = 1}^{M} ( \frac{{P}_{i , panel}}{Q} \times {τ}_{i , panel} \times {τ}_{i , trim} \times \frac{{P}_{ear}}{{P}_{i , trim}} ) \\ = {\sum }_{i = 1}^{M} \{ \frac{{P}_{i , panel}}{Q} \times \frac{ERPWPC}{{P}_{i , panel}^{2}} \times {( \frac{{V}_{i , trim}}{{V}_{i , panel}} )}^{2} \times \frac{{P}_{ear}}{{Q}_{i , trim}} \}\end{matrix} \qquad ( Formula 11 )$$

M in Formula 11 is the number of panel members 36 included in the body panel 30 of the vehicle. Thus, the total acoustic sensitivity Pₑₐᵣ/Q illustrated in Formula 10 is an acoustic transfer function from the sound source to the measurement position in consideration of a plurality of acoustic transfer paths from the sound source to the measurement position via all the panel members 36 included in the body panel 30 of the vehicle.

Note that a case is considered where, among a plurality of panel members 36 constituting the body panel 30 of the vehicle, some panel members provided with the soundproof material 44 and other panel members not provided with the soundproof material are mixed. In this case, the sound transmission analyzing unit 26 calculates the acoustic sensitivity P_{i,ear}/Q using the outside-of-panel acoustic transfer function 18, the panel transmission function 20, the soundproof material surface vibration ratio 22, and the first inside-of-panel acoustic transfer function Pₑₐᵣ/Q_{i,trim} for each panel member 36 provided with the soundproof material 44, and calculates the acoustic sensitivity P_{i,ear}/Q using the outside-of-panel acoustic transfer function 18, the panel transmission function 20, and the second inside-of-panel acoustic transfer function Pₑₐᵣ/Q_{i,panel} for each panel member 36 not provided with the soundproof material 44.

The acoustic sensitivity P_{i,ear}/Q for each panel member 36 is acquired for each frequency. Thus, the sound transmission analyzing unit 26 also acquires the total acoustic sensitivity Pₑₐᵣ/Q for each frequency by totaling the acoustic sensitivity P_{i,ear}/Q for each panel member 36 for each frequency. The sound transmission analyzing unit 26 can generate a graph indicating the relationship between the total acoustic sensitivity Pₑₐᵣ/Q and the frequency.

FIG. 13 is a graph illustrating an example of the relationship between the total acoustic sensitivity Pₑₐᵣ/Q and a frequency. In the graph, the ordinate represents the total acoustic sensitivity Pₑₐᵣ/Q, and the abscissa represents the frequency. The graph is also provided to a user. As a result, the user can evaluate how much the sound at each frequency as emitted from the sound source is transmitted to the measurement position via a plurality of acoustic transfer paths including the air and each panel member 36 (or additionally the soundproof material 44).

As described above, the body panel 30 of the vehicle is configured to include a plurality of panel sections 32 each including one or more panel members 36. Here, the sound transmission analyzing unit 26 can calculate, for each panel section 32, a section acoustic sensitivity P_{k,ear}/Q (section acoustic sensitivity P_{k,ear}/Q from the sound source via the panel section 32 to the measurement position) for the panel section 32 on the basis of the acoustic sensitivities P_{i,ear}/Q of one or more panel members 36 constituting the panel section 32. Note that the subscript k indicates a panel section 32.

Specifically, the section acoustic sensitivity P_{k,ear}/Q for a certain panel section 32 can be obtained by totaling the acoustic sensitivities P_{i,ear}/Q of one or more panel members 36 constituting the panel section 32. For example, the acoustic sensitivities of a plurality of panel members 36 constituting the back panel are totaled to give the section acoustic sensitivity P_{k,ear}/Q for the entire back panel. The section acoustic sensitivities P_{k,ear}/Q for all the panel sections 32 constituting the body panel 30 of the vehicle are totaled to give the total acoustic sensitivity Pₑₐᵣ/Q.

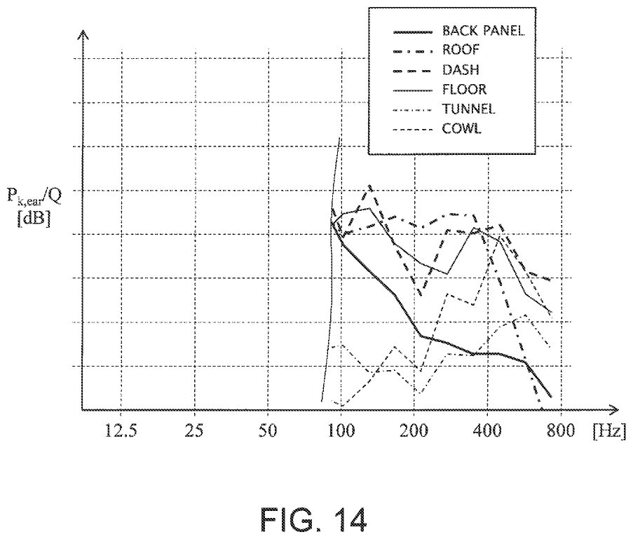

The sound transmission analyzing unit 26 generates a graph indicating the relationship between the section acoustic sensitivity P_{k,ear}/Q and a frequency for each panel section 32. The graph is illustrated in FIG. 14. In the graph, the ordinate represents the section acoustic sensitivity P_{k,ear}/Q, and the abscissa represents the frequency. The graph is also provided to a user. As a result, the user can grasp the section acoustic sensitivity P_{k,ear}/Q for each panel section 32 with respect to sound transmission from the sound source to the measurement position.

The sound transmission analyzing unit 26 calculates, based on the section acoustic sensitivity P_{k,ear}/Q for each panel section 32, the contribution of each panel section 32 with respect to the sound transmission from the sound source to the measurement position. For example, when the total acoustic sensitivity Pₑₐᵣ/Q is set to 100 [%], the percentage of the section acoustic sensitivity P_{k,ear}/Q for each panel section 32 in the total acoustic sensitivity Pₑₐᵣ/Q is the contribution of each panel section 32. The greater the contribution, the greater the panel section 32 contributes to the sound transmission from the sound source to the measurement position. The section acoustic sensitivity P_{k,ear}/Q for each panel section 32 is obtained for each frequency. Accordingly, the contribution is also obtained for each frequency. That is, the sound transmission analyzing unit 26 calculates the contribution of each panel section 32 with respect to the sound transmission from the sound source to the measurement position for each frequency.

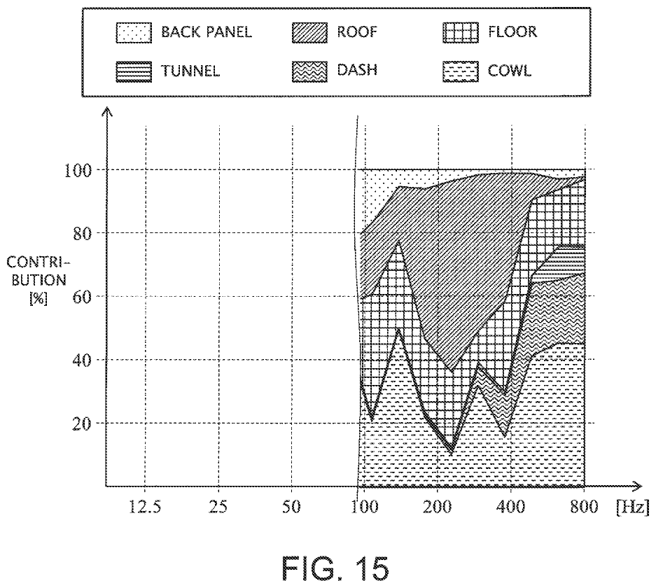

A user can also read the contribution of each panel section 32 from the graph illustrated in FIG. 14. Meanwhile, the user can more intuitively grasp the contribution of each panel section 32 with respect to the sound transmission from the sound source to the measurement position. In this way, the sound transmission analyzing unit 26 may generate a stacked area graph indicating the relationship between the contribution of each panel section 32 and a frequency, as illustrated in FIG. 15. In the stacked area graph illustrated in FIG. 15, the ordinate represents the contribution, and the abscissa represents the frequency. From the graph, the user can more intuitively grasp the contribution of each panel section 32 with respect to the sound transmission from the sound source to the measurement position.

The sound transmission analyzer 10 according to this embodiment is as described above. The sound transmission analyzer 10 according to this embodiment is configured to calculate an acoustic transfer function involving a transmission sound transmitted through a panel member(s) 36 from a sound source on the basis of the outside-of-panel acoustic transfer function 18, which is an acoustic transfer function involving an airborne sound from the sound source to the outer surface 36o of the panel member 36. Thus, the transmission analyzer according to this embodiment can be used to analyze the sound transmission involving the panel member(s) 36 in consideration of a sound emitted from the sound source, propagated in the air, and input to the outer surface 36o of the panel member 36.

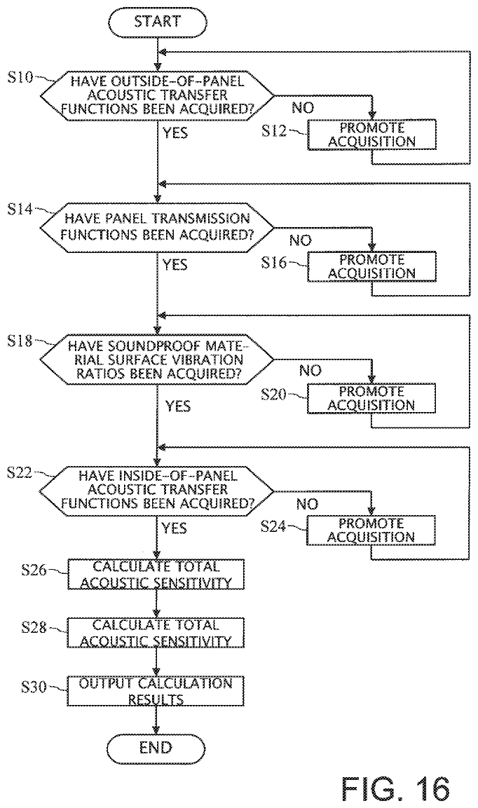

Hereinafter, how the processing of the sound transmission analyzing unit 26 is processed will be described according to the flowchart shown in FIG. 16.

In step S10, the sound transmission analyzing unit 26 determines whether or not the outside-of-panel acoustic transfer functions 18 have been acquired and are stored in the storage unit 16 or a device accessible from the sound transmission analyzer 10. In this processing, all the panel members 36 constituting the body panel 30 of the vehicle are analyzed. Thus, in step S10, whether or not the outside-of-panel acoustic transfer functions 18 for all the panel members 36 have been acquired is determined.

In a case where the outside-of-panel acoustic transfer functions 18 for all the panel members 36 have been acquired, the process goes to step S14. In a case where the outside-of-panel acoustic transfer functions 18 for any of the panel members 36 have not been acquired, the process goes to step S12. In step S12, the sound transmission analyzing unit 26 presents a notification for prompting acquisition of the outside-of-panel acoustic transfer functions 18 to a user. Note that the notification is presented by, for example, transmitting a notification message from the communication unit 12 to a user terminal or displaying the notification message on the display unit 14. When the outside-of-panel acoustic transfer functions 18 of interest are acquired by the user, it is determined that the outside-of-panel acoustic transfer functions 18 for all the panel members 36 have been acquired in step S10 again. Then, the process goes to step S14.

In step S14, the sound transmission analyzing unit 26 determines whether or not the panel transmission functions 20 for all the panel members 36 have been acquired and are stored in the storage unit 16 or a device accessible from the sound transmission analyzer 10.

In a case where the panel transmission functions 20 for all the panel members 36 have been acquired, the process goes to step S18. In a case where the panel transmission functions 20 for any of the panel members 36 have not been acquired, the process goes to step S16. In step S16, the sound transmission analyzing unit 26 presents a notification for prompting acquisition of the panel transmission functions 20 to the user. When the panel transmission functions 20 of interest are acquired by the user, it is determined that the panel transmission functions 20 for all the panel members 36 have been acquired in step S14 again. Then, the process goes to step S18.

In step S18, the sound transmission analyzing unit 26 determines whether or not the soundproof material surface vibration ratios 22 for all the panel members 36 provided with the soundproof material 44 have been acquired and are stored in the storage unit 16 or a device accessible from the sound transmission analyzer 10.

In a case where the soundproof material surface vibration ratios 22 for all the panel members 36 provided with the soundproof material 44 have been acquired, the process goes to step S22. In a case where the soundproof material surface vibration ratios 22 for any of the panel members 36 provided with the soundproof material 44 have not been acquired, the process goes to step S20. In step S20, the sound transmission analyzing unit 26 presents a notification for prompting acquisition of the soundproof material surface vibration ratios 22 to the user. When the soundproof material surface vibration ratios 22 of interest are acquired by the user, it is determined that the soundproof material surface vibration ratios 22 for all the panel members 36 provided with the soundproof material 44 have been acquired in step S18 again. Then, the process goes to step S22.

In step S22, the sound transmission analyzing unit 26 determines whether or not the inside-of-panel acoustic transfer functions 24 for all the panel members 36 have been acquired and are stored in the storage unit 16 or a device accessible from the sound transmission analyzer 10.

In a case where the inside-of-panel acoustic transfer functions 24 for all the panel members 36 have been acquired, the process goes to step S26. In a case where the inside-of-panel acoustic transfer functions 24 for any of the panel members 36 have not been acquired, the process goes to step S24. In step S24, the sound transmission analyzing unit 26 presents a notification for prompting acquisition of the inside-of-panel acoustic transfer functions 24 to the user. When the inside-of-panel acoustic transfer functions 24 of interest are acquired by the user, it is determined that the inside-of-panel acoustic transfer functions 24 for all the panel members 36 have been acquired in step S22 again. Then, the process goes to step S26.

In step S26, the sound transmission analyzing unit 26 calculates the total acoustic sensitivity Pₑₐᵣ/Q by totaling the products of the outside-of-panel acoustic transfer function 18, the panel transmission function 20, the soundproof material surface vibration ratio 22, and the inside-of-panel acoustic transfer function 24 for the plurality of panel members 36.

In step S28, the sound transmission analyzing unit 26 calculates, for each panel section 32, the section acoustic sensitivity P_{k,ear}/Q for the panel section 32 by totaling the acoustic sensitivities P_{i,ear}/Q of one or more panel members 36 constituting the panel section 32. In addition, the sound transmission analyzing unit 26 calculates, based on the section acoustic sensitivity P_{k,ear}/Q for each panel section 32, the contribution of each panel section 32 with respect to the sound transmission from the sound source to the measurement position.

In step S30, the sound transmission analyzing unit 26 outputs the calculation results of steps S26 and S28. For example, a graph indicating the relationship between the total acoustic sensitivity Pₑₐᵣ/Q and a frequency (see FIG. 13) is displayed on the display unit 14. In addition, a graph indicating the relationship between the section acoustic sensitivity P_{k,ear}/Q for each panel section 32 and a frequency (see FIG. 14) is displayed on the display unit 14. Further, a stacked area graph indicating the relationship between the contribution of each panel section 32 and a frequency (see FIG. 15) is displayed on the display unit. Note that these items of information may be displayed on the display unit of a user terminal by being transmitted to the user terminal used by the user.

The embodiment of the automatic driving vehicle according to the present disclosure has been described above. However, the automatic driving vehicle according to the present disclosure is not limited to the above embodiment, and various modifications can be made without departing from the gist of the present disclosure.

For example, in the above embodiment, it is assumed that the sound source is an engine, but of course, the sound source is not limited to the engine. For example, the sound source may be a front tire. In this case, the outside-of-panel acoustic transfer function 18 is acquired after the speaker 40 is installed near the front tire.

1. A sound transmission analyzer for a panel member of a vehicle, comprising
a sound transmission analyzing unit configured to calculate an acoustic transfer function from a sound source via air to an inner surface of a panel member on a basis of an outside-of-panel acoustic transfer function that is an acoustic transfer function involving an airborne sound from the sound source located outside the panel member of the vehicle to an outer surface of the panel member, and a panel transmission function that is an acoustic transfer function from the outer surface of the panel member to the inner surface of the panel member.

2. The sound transmission analyzer for a panel member of a vehicle according to claim 1, wherein
a soundproof material is provided on an inner side of the panel member, and
the sound transmission analyzing unit calculates an acoustic transfer function from the sound source via the air and the panel member to an inner surface of the soundproof material further on a basis of a soundproof material surface vibration ratio that is a ratio between a vibration velocity in a normal direction of the panel member and a vibration velocity in a normal direction of the inner surface of the soundproof material.

3. The sound transmission analyzer for a panel member of a vehicle according to claim 2, wherein
the sound transmission analyzing unit calculates an acoustic sensitivity that is an acoustic transfer function from the sound source, via the air, the panel member, and the soundproof material, to a measurement position further on a basis of a first inside-of-panel acoustic transfer function that is an acoustic transfer function involving an airborne sound from the inner surface of the soundproof material to the measurement position in the panel member.

4. The sound transmission analyzer for a panel member of a vehicle according to claim 1, wherein
the sound transmission analyzing unit calculates an acoustic sensitivity that is an acoustic transfer function from the sound source via the air and the panel member to a measurement position further on a basis of a second inside-of-panel acoustic transfer function that is an acoustic transfer function involving an airborne sound from the inner surface of the panel member to the measurement position in the panel member.

5. The sound transmission analyzer for a panel member of a vehicle according to claim 1, wherein
the panel member comprises a plurality of elements as a plurality of small regions, and
the panel transmission function is obtained based on equivalent radiated power with phase considered as calculated based on an absolute value for a sum of products of a vibration velocity in a normal direction of each element and an area of each element.

6. The sound transmission analyzer for a panel member of a vehicle according to claim 3, wherein
the sound transmission analyzing unit calculates the acoustic sensitivity for each panel member of the vehicle, and uses the acoustic sensitivity for each panel member to calculate a total acoustic sensitivity that is an acoustic transfer function from the sound source to the measurement position in consideration of a plurality of acoustic transfer paths from the sound source via the air and each panel member to the measurement position.

7. The sound transmission analyzer for a panel member of a vehicle according to claim 4, wherein
the sound transmission analyzing unit calculates the acoustic sensitivity for each panel member of the vehicle, and uses the acoustic sensitivity for each panel member to calculate a total acoustic sensitivity that is an acoustic transfer function from the sound source to the measurement position in consideration of a plurality of acoustic transfer paths from the sound source via the air and each panel member to the measurement position.

8. The sound transmission analyzer for a panel member of a vehicle according to claim 1, wherein
a body panel of the vehicle comprises a plurality of panel sections each composed of one or more of the panel members, and
the sound transmission analyzing unit calculates, for each panel section, a section acoustic sensitivity from the sound source via the panel section to the measurement position on a basis of acoustic sensitivities for the one or more panel members constituting the panel section.

9. The sound transmission analyzer for a panel member of a vehicle according to claim 8, wherein
the sound transmission analyzing unit calculates, based on the section acoustic sensitivity for each panel section, a contribution of each panel section with respect to sound transmission from the sound source to the measurement position.
